(19) United States
(12) Patent Application Publication
(10) Pub. No.: US 2009/0186313 A1
(43) Pub. Date: Jul. 23, 2009

(54) Metallic dental devices with tooth colors and their preparation methods

(75) Inventors: Sinn-Wen Chen, Hsinchu (TW); Hsin-Jay Wu, Hsinchu (TW); Li-Ling Huang, Hsinchu (TW); Eric Jein-Wein Liou, Taoyuan (TW)

Correspondence Address: BACON & THOMAS, PLLC, 625 SLATERS LANE, FOURTH FLOOR, ALEXANDRIA, VA, 22314-1176, US

(73) Assignees: National Tsing Hua University, Hsinchu (TW); Chang-Gung Memorial Hospital, Taoyuan (TW)

(21) Appl. No.: 12/314,952

(22) Filed: Dec. 19, 2008

(30) Foreign Application Priority Data
Jan. 22, 2008 (TW) 97102412

(51) Int. Cl. A61C 7/20

(52) U.S. Cl. 433/16; 433/215

(57) ABSTRACT

Metallic devices are frequently used in dental treatments, such as orthodontic archwires, rackets, or dental mini-screws. This invention provides metallic dental devices with a color of tooth or close to tooth, and their preparation methods.

### FIELD OF THE INVENTION

The present invention relates to metallic dental devices with tooth colors different from the original metallic gloss, and a method for preparing the metallic archwires. The invented method includes subjecting the metallic such as orthodontic archwires to an anodizing treatment or plasma treatment.

### BACKGROUND OF THE INVENTION

Healthy and beautiful teeth are becoming more and more important to the modem people. Consequently, Orthodontics has become a popular dental treatment. For cosmetic reasons, dental devices having tooth colors are welcome, for examples the popular ceramic artificial teeth, and synthetic resins for filling cavities on teeth, both having colors close to tooth. Metallic dental devices are frequently used in the dental treatments, such as orthodontic archwires, rackets, or dental mini-screws. So far there are no metallic dental devices having a color of tooth or close to tooth, and of course preparation methods thereof are also absent.

The above-mentioned metallic dental devices all have bright metallic color. For cosmetic reasons, some orthodontic archwires are transparent, or even transparent with a nano structure. For example, Lemchen recently proposed a very different mesoporous alloidal orthodontic archwire [M. S. Lemchen, U.S. Pat. No. 6,056,545, (2000)]. The mesoporous alloidal orthodontic archwire invented by Lemchen has a transparency derived from the mesoporous nature thereof; it is expected that the mechanical strength thereof is inferior to the original dense material. This is a serious restriction on the use of orthodontic archwires.

One of the inventor of the present application and his co-coworkers disclose in US 2005/0214709 metallic archwires or dental crowns with various colors, which can be prepared by subjecting the orthodontic archwires or metallic dental crowns to an anodizing treatment, and further in US 2006/0199139 disclose orthodontic archwires with more than one colors, which can be prepared by subjecting the orthodontic archwires to an anodizing treatment. However, there is no disclosure related to a metallic dental device having a color of tooth or close to tooth, and to a preparation method thereof.

### SUMMARY OF THE INVENTION

A primary objective is to provide a metallic dental device, such as orthodontic archwires, rackets, or dental mini-screws, having a color of tooth or close to tooth, and said tooth color is not formed by applying a pigment or ink to a surface of the metallic dental device, but subjecting the metallic device to a surface treatment such as anodizing or plasma treatments, thereby altering the metallic color and gloss of the metallic dental device.

### BRIEF DESCRIPTION OF THE DRAWINGS

FIG. 1 is a photo showing an orthodontic archwire having a tooth color on its left side, which was immersed in an electrolytic solution and subjected to an anodizing treatment in Example 1 of the present invention.

FIG. 2 is a photo showing an orthodontic archwire having a tooth color on its left side, which was immersed in an electrolytic solution and subjected to an anodizing treatment in Example 2 of the present invention.

FIG. 3 is a photo showing an orthodontic archwire having a tooth color on its left side, which was immersed in an electrolytic solution and subjected to an anodizing treatment in Example 3 of the present invention.

FIG. 4 is a photo showing an orthodontic archwire having a tooth color on its left side, which was immersed in an electrolytic solution and subjected to an anodizing treatment in Example 4 of the present invention.

FIG. 5 is a photo showing an orthodontic archwire having a tooth color on its left side, which was immersed in an electrolytic solution and subjected to an anodizing treatment in Example 5 of the present invention.

FIG. 6 is a photo showing an orthodontic archwire having a tooth color on its left side, which was immersed in an electrolytic solution and subjected to an anodizing treatment in Example 6 of the present invention.

### DETAILED DESCRIPTION OF THE PREFERRED EMBODIMENTS

The present invention discloses a metallic dental device, such as orthodontic archwires, rackets, or dental mini-screws, having a color of tooth or close to tooth, and said tooth color is not formed by applying a pigment or ink to a surface of the metallic dental device. In one of the preferred embodiments of the present invention, metallic orthodontic archwires having tooth colors or close to tooth colors were prepared.

Preferably, said tooth colors or close to tooth colors are formed by subjecting the metallic device to an anodizing treatment.

Preferably, said orthodontic archwires are made of pure β-Ti, an alloy mainly composed of titanium or a stainless steel, and pure β-Ti, an alloy mainly composed of titanium are more preferably.

Preferably, said tooth color has a lightness (L) of 60 to 80, a redness (a) of −0.9 to 8, and a yellowness (b) of −0.2 to 20. More preferably, L is greater than 65, a is greater than 0.3, and b is greater than 4.5.

The present invention also discloses a method for preparing a metallic dental device, which comprises the following steps:

a) cleaning a metallic dental device; and

b) performing an anodizing treatment or plasma treatment on the cleaned metallic dental device from step a) in order to obtain a tooth color on the surface of said metallic dental device, wherein an electrolytic solution used in said anodizing treatment is an acidic aqueous solution.

Preferably, step b) comprises performing said anodizing treatment.

Preferably, an operation voltage of said anodizing treatment is 10 V-60 V.

Preferably, said orthodontic device is an anode in said anodizing treatment, and said electrolytic solution comprises at least one acid selected from the group consisting of H₂SO₄, H₃PO₄, and HF. More preferably, said electrolytic solution comprises H₂SO₄.

Preferably, said electrolytic solution further comprises H₂O₂.

The biocompatibility of an orthodontic archwire is very important because such an orthodontic archwire is mounted on the teeth of a person. Therefore, an ordinary dying or pigment coating technique can not be applied on the coloring of an orthodontic archwire. The coloring method of anodizing treatment according to the present invention uses the optical interference effect of the oxide film on the surface of the material without external addition of a pigment. The products resulting from the anodizing treatment are oxides of the metallic elements of the orthodontic archwire, which are formed on the surface of the orthodontic archwire. For an ordinary metal element, its oxide is often more stable than the metal element, that is the biocompatibility after anodizing treatment will become better. Therefore, the anodizing treatment will not introduce an additional biocompatibility problem. Furthermore, the anodizing treatment according to the present invention only oxidizes the surface of the material such that the mechanical strength of the orthodontic archwire will not be affected conspicuously. In other words, an anodizing treatment can alter the outlook color of an orthodontic archwire, without significantly changing the biocompatibility and mechanical strength thereof (wherein the former might be increased slightly, while the later might be decreased or increased slightly).

### Example 1

An orthodontic archwire of β-Ti alloy having Ti: 77.79%, Zr: 6.06%, Mo: 11.27%, and Sn: 4.88% (Code No. 101-009, ORTHO ORGANIZERS, INC.) was used as a specimen (0.017 inch×0.025 inch) in an anodizing treatment, wherein the electrolytic solution used was an aqueous solution having 0.25 M H₂SO₄, 0.15 M H₂O₂, 0.075 M H₃PO₄ and 0.0075 M HF, the anode was said orthodontic archwire, the cathode was a platinum plate, and the power supply was a LPS 305 from the MOTECH Co.

Said orthodontic archwire was polished in sequence with SiC sandpapers of #1000, #1200, #2400 and #4000, and alumina powder. The polished orthodontic archwire was immersed in 0.5 M NaOH aqueous solution and under an ultrasonic oscillation for 10 minutes. This alkaline washing treatment removed esters on the surface and activated the surface of the metal in order to achieve a uniform surface property. Next, said orthodontic archwire was immersed in a hydrochloric acid solution (0.2 M) and subjected to an ultrasonic oscillation for 2 minutes in order to remove oxides on the metal surface, followed by washing with a large quantity of distilled water and drying by blowing. The above cleaning steps were all carried out at room temperature. A constant voltage was used to perform an anodizing treatment on the clean orthodontic archwire having a length of about 1.5 cm at room temperature (25° C.), wherein the voltage used was 20 V, and the anodizing treatment time was 360 minutes. Next, said orthodontic archwire was removed, washed with distilled water, and dried by blowing.

### Example 2

The procedures in Example 1 were repeated except that the electrolytic solution used was an aqueous solution having 1 M H₂SO₄, 0.15 M H₂O₂, and 0.075 M H₃PO₄, and the anodizing treatment time was 240 minutes.

### Example 3

The procedures in Example 1 were repeated except that the electrolytic solution used was an aqueous solution having 1 M H₂SO₄, and 0.15 M H₂O₂, and the anodizing treatment time was 180 minutes.

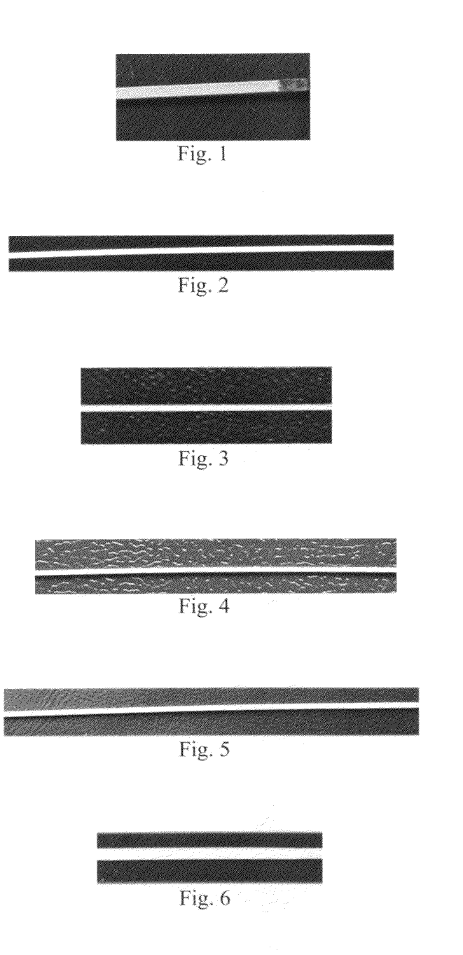

FIG. 1 to FIG. 3 are photographs showing the orthodontic archwires prepared in Examples 1 to 3 have tooth colors. Table 1 lists the lightness (L), redness (a) and yellowness (b) of the orthodontic archwires before and after the anodizing treatments carried out in Examples 1 to 3.

TABLE 1

| | L | a | b |
|---|---|---|---|
| Example 1 | 68.57 | −0.82 | 6.36 |
| Example 2 | 72.17 | −0.76 | 7.45 |
| Example 3 | 79.79 | −0.81 | 13.62 |
| Without treatment | 65 | 0.3 | 4.5 |

### Example 4

The electrolytic solution and the cleaning procedures used in this example were the same as those used in Example 2. The orthodontic archwire having a length of 5 cm was subjected to the anodizing treatment with the same anodizing system except that the cathode was a silver plate of 1 cm×3 cm×0.05 cm. The anodizing voltage was 20 V and the anodizing time was 180 minutes. The treated orthodontic archwire has a tooth color as shown in FIG. 4.

### Example 5

The procedures in Example 4 were repeated except that the electrolytic solution used was an aqueous solution having 1 M H₂SO₄ and the anodizing treatment time was 120 minutes. The treated orthodontic archwire has a tooth color as shown in FIG. 5.

### Example 6

The procedures in Example 4 were repeated except that the electrolytic solution used was an aqueous solution having 1 M H₂SO₄ and 0.3 M H₂O₂, and the anodizing voltage and anodizing treatment time were 30 V and 120 minutes, respectively. The treated orthodontic archwire has a tooth color as shown in FIG. 6.

1. A metallic dental device having a color of tooth, wherein said color is not formed by using a pigment or ink.

2. The metallic dental device as claimed in claim 1, which is an orthodontic archwire, racket, or dental mini-screw.

3. The metallic dental device as claimed in claim 1, which is an orthodontic archwire.

4. The metallic dental device as claimed in claim 1, wherein said color is formed by subjecting the orthodontic device to an anodizing treatment.

5. The metallic dental device as claimed in claim 1, which is made of pure titanium, an alloy mainly consisting of titanium, or a stainless steel.

6. The metallic dental device as claimed in claim 5, which is made of pure β-Ti.

7. The metallic dental device as claimed in claim 5, which is made of an alloy mainly consisting of Ni and Ti.

8. The metallic dental device as claimed in claim 1, wherein said color has a lightness (L) of 60 to 80, a redness (a) of −0.9 to 8, and a yellowness (b) of −0.2 to 20.

9. The metallic dental device as claimed in claim 8, wherein L is greater than 65, a is greater than 0.3, and b is greater than 4.5.

10. A method for preparing a metallic dental device, which comprises the following steps:
a) cleaning a metallic dental device; and
b) performing an anodizing treatment or plasma treatment on the cleaned metallic dental device from step a) in order to obtain a tooth color on the surface of said metallic dental device, wherein an electrolytic solution used in said anodizing treatment is an acidic aqueous solution.

11. The method as claimed in claim 10, wherein said metallic dental device is an orthodontic archwire, racket, or dental mini-screw.

12. The method as claimed in claim 10, wherein said orthodontic device is an orthodontic archwire.

13. The method as claimed in claim 10, wherein said tooth color is formed by subjecting the orthodontic device to said anodizing treatment in step b).

14. The method as claimed in claim 10, wherein said orthodontic device is made of pure titanium, an alloy mainly consisting of titanium, or a stainless steel.

15. The method as claimed in claim 14, wherein said orthodontic device is made of pure β-Ti.

16. The method as claimed in claim 14, wherein said orthodontic device is made of an alloy mainly consisting of Ni and Ti.

17. The method as claimed in claim 10, wherein said color has a lightness (L) of 60 to 80, a redness (a) of −0.9 to 8, and a yellowness (b) of −0.2 to 20.

18. The method as claimed in claim 17, wherein L is greater than 65, a is greater than 0.3, and b is greater than 4.5.

19. The method as claimed in claim 10, wherein an operation voltage of said anodizing treatment is 10 V-60 V.

20. The method as claimed in claim 10, wherein said orthodontic device is an anode in said anodizing treatment, and said electrolytic solution comprises at least one acid selected from the group consisting of H₂SO₄, H₃PO₄, and HF.

21. The method as claimed in claim 20, wherein said electrolytic solution comprises H₂SO₄.

22. The method as claimed in claim 20, wherein said electrolytic solution further comprises H₂O₂.
